(19) United States
(12) Patent Application Publication
(10) Pub. No.: US 2023/0394125 A1
(43) Pub. Date: Dec. 7, 2023

(54) SERVER DEVICE, VISITOR NOTIFICATION SYSTEM, VISITOR NOTIFICATION METHOD, AND STORAGE MEDIUM

(71) Applicant: NEC Corporation, Minato-ku, Tokyo (JP)

(72) Inventors: Satoshi HIRATA, Tokyo (JP); Hajime Yamashita, Tokyo (JP); Kenta Aino, Tokyo (JP); Yuto Nishikawa, Tokyo (JP)

(73) Assignee: NEC Corporation, Minato-ku, Tokyo (JP)

(21) Appl. No.: 18/033,311

(22) PCT Filed: Nov. 6, 2020
(86) PCT No.: PCT/JP2020/041547

§ 371 Date: Apr. 21, 2023

(51) Int. Cl. G06F 21/32; G06T 7/70; G06V 40/16; G07C 9/25

(52) U.S. Cl. CPC G06F 21/32; G06T 7/70; G06V 40/171; G06V 40/172; G07C 9/25

(57) ABSTRACT

Provided is a server device capable of recognizing the visit of a specific customer. A server device (100) includes an acquisition unit (101), a determination unit (102), and a notification unit (103). The acquisition unit (101) acquires, from a reception terminal installed in an event venue, ticket information of a ticket presented by a visitor for whom visitor registration is to be performed in the reception terminal. The determination unit (102) determines, based on the ticket information, whether or not the visitor matches a first person. When the visitor matches the first person, the notification unit (103) notifies a second person that the first person has visited the event venue.

### TECHNICAL FIELD

The present invention relates to a server device, a visitor notification system, a visitor notification method, and a storage medium.

### BACKGROUND ART

In recent years, various services using biometric information have started to spread. For example, facial authentication is used to check into a hotel, confirm entrance qualification to an event venue, and the like.

For example, Patent Literature 1 describes providing an information processing system capable of solving a problem that it takes time and effort to pre-register a person in a system for performing person verification in a venue. An information processing device described in Patent Literature 1 includes storage processing means and verification means. The storage processing means acquires an image of a person who has issued a ticket at the time of issuing the ticket, and stores authentication information based on the image of the person and seat information for specifying a seat of the issued ticket in association with each other. The verification means acquires a venue image obtained by capturing the inside of a venue where the seat of the issued ticket is installed, and extracts, based on the venue image, a pair of authentication information of a person in a venue image and seat information of a seat where the person is located. The verification means performs verification processing of determining whether the extracted authentication information of the person and the seat information of the seat are stored as the pair in association with each other.

In addition, Patent Literature 2 discloses a guest visit notification system in an event venue.

### CITATION LIST

### Patent Literature

Patent Literature 1: Japanese Unexamined Patent Application Publication No. 2019-144933
Patent Literature 2: Japanese Unexamined Patent Application Publication No. 2001-357159

### SUMMARY OF INVENTION

### Technical Problem

Various events are held in a soccer stadium, a concert hall, or the like. Visitors to an event include a customer important to the event organizer. When the important customer appears at the event venue, a person (staff member) of the event company who is in charge has a desire to visit the customer and perform sales activities or the like.

However, the event organizer cannot grasp in advance the time, place, and the like at which such an important customer appears at the event venue, and the sales activities and the like are difficult. Note that this problem cannot be solved by applying the techniques disclosed in Patent Literatures 1 and 2. Patent Literature 1 is not intended to notify visitors. Further, in Patent Literature 2, it is not assumed that the visit of an important person among a large number of visitors is notified.

It is a main object of the present invention to provide a server device, a visitor notification system, a visitor notification method, and a storage medium that contribute to making it possible to grasp the visit of a specific customer.

### Solution to Problem

According to a first aspect of the present invention, there is provided a server device including: an acquisition unit configured to acquire, from a reception terminal installed in an event venue, ticket information of a ticket presented by a visitor for whom visitor registration is to be performed in the reception terminal; a determination unit configured to determine, based on the ticket information, whether or not the visitor matches a first person; and a notification unit configured to notify, when the visitor matches the first person, a second person that the first person has visited the event venue.

According to a second aspect of the present invention, there is provided a visitor notification system including: a reception terminal installed in an event venue; and a server device connected to the reception terminal, in which the server device includes: an acquisition unit configured to acquire, from the reception terminal, ticket information of a ticket presented by a visitor for whom visitor registration is to be performed in the reception terminal; a determination unit configured to determine, based on the ticket information, whether or not the visitor matches a first person; and a notification unit configured to notify, when the visitor matches the first person, a second person that the first person has visited the event venue.

According to a third aspect of the present invention, there is provided a visitor notification method including, by a server device: acquiring, from a reception terminal installed in an event venue, ticket information of a ticket presented by a visitor for whom visitor registration is to be performed in the reception terminal; determining, based on the ticket information, whether or not the visitor matches a first person; and notifying, when the visitor matches the first person, a second person that the first person has visited the event venue.

According to a fourth aspect of the present invention, there is provided a computer-readable storage medium storing a program for causing a computer installed in a server device to execute: processing of acquiring, from a reception terminal installed in an event venue, ticket information of a ticket presented by a visitor for whom visitor registration is to be performed in the reception terminal; processing of determining, based on the ticket information, whether or not the visitor matches a first person; and processing of notifying, when the visitor matches the first person, a second person that the first person has visited the event venue.

### Advantageous Effects of Invention

According to each aspect of the present invention, there are provided a server device, a visitor notification system, a visitor notification method, and a storage medium that contribute to making it possible to grasp the visit of a specific customer. Note that the effects of the present invention are not limited to the above. According to the present invention, other effects may be exhibited instead of or in addition to the effects.

### BRIEF DESCRIPTION OF DRAWINGS

FIG. 1 is a diagram for explaining an outline of an example embodiment.

FIG. 2 is a diagram illustrating an example of a schematic configuration of a visitor notification system according to a first example embodiment.

FIG. 3A is a diagram for explaining an operation of a reception terminal according to the first example embodiment.

FIG. 3B is a diagram for explaining an operation of the reception terminal according to the first example embodiment.

FIG. 3C is a diagram for explaining an operation of the reception terminal according to the first example embodiment.

FIG. 3D is a diagram for explaining an operation of the reception terminal according to the first example embodiment.

FIG. 4 is a diagram for explaining an operation of the reception terminal according to the first example embodiment.

FIG. 5 is a diagram for explaining an operation of a terminal according to the first example embodiment.

FIG. 6 is a diagram illustrating an example of a processing configuration of a server device according to the first example embodiment.

FIG. 7 is a diagram illustrating an example of a VIP member information database according to the first example embodiment.

FIG. 8 is a diagram illustrating an example of a visitor information database according to the first example embodiment.

FIG. 9 is a diagram illustrating an example of a processing configuration of the reception terminal according to the first example embodiment.

FIG. 10 is a diagram illustrating an example of a processing configuration of an authentication terminal according to the first example embodiment.

FIG. 11 is a sequence diagram illustrating an example of an operation of the visitor notification system according to the first example embodiment.

FIG. 12 is a diagram illustrating an example of a schematic configuration of a visitor notification system according to a second example embodiment.

FIG. 13 is a diagram illustrating an example of a processing configuration of a server device according to the second example embodiment.

FIG. 14 is a diagram illustrating an example of table information held in the server device according to the second example embodiment.

FIG. 15 is a diagram illustrating an example of a visitor information database according to the second example embodiment.

FIG. 16 is a diagram for explaining an operation of a terminal according to the second example embodiment.

FIG. 17 is a sequence diagram illustrating an example of an operation of the visitor notification system according to the second example embodiment.

FIG. 18 is a diagram illustrating an example of a processing configuration of a server device according to a third example embodiment.

FIG. 19 is a diagram illustrating an example of a staff information database according to the third example embodiment.

FIG. 20 is a diagram for explaining an operation of a terminal according to the third example embodiment.

FIG. 21 is a diagram for explaining an operation of the terminal according to the third example embodiment.

FIG. 22 is a diagram illustrating an example of a hardware configuration of a server device.

FIG. 23 is a diagram for explaining an operation of a terminal according to a modified example of the disclosure of the present application.

FIG. 24 is a diagram for explaining an operation of the terminal according to the modified example of the disclosure of the present application.

### EXAMPLE EMBODIMENTS

First, an outline of an example embodiment will be described. Note that the reference numerals in the drawings described in this outline are used to refer to each element for convenience as an example for assisting understanding, and the description of this outline is not intended to be any limitation. In addition, in a case where there is no particular explanation, a block described in each drawing represents not a configuration of a hardware unit but a configuration of a functional unit. Connection lines between blocks in each drawing include both bidirectional and unidirectional lines. Each unidirectional arrow schematically indicates a flow of a main signal (data), and does not exclude bidirectionality. Note that, in the present specification and the drawings, elements that can be similarly described are denoted by the same reference numerals, and redundant description can be omitted.

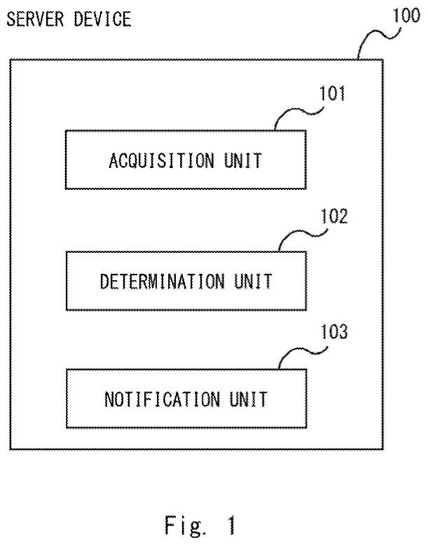

A server device 100 according to one example embodiment includes an acquisition unit 101, a determination unit 102, and a notification unit 103 (see FIG. 1). The acquisition unit 101 acquires, from a reception terminal installed in an event venue, ticket information of a ticket presented by a visitor for whom visitor registration is to be performed in the reception terminal. The determination unit 102 determines, based on the ticket information, whether or not the visitor matches a first person. When the visitor matches the first person, the notification unit 103 notifies a second person that the first person has visited the event venue.

The server device 100 acquires the information of the ticket owned by the important customer (first person; a VIP member to be described later) who has visited the event venue. The server device 100 notifies, based on the information of the ticket, the staff member (second person) of the event company that the important customer has arrived at the event venue. The staff member of the event company can grasp the visit of the specific customer (important customer) based on the notification from the server device 100, and can take measures such as going to the customer.

Hereinafter, specific example embodiments will be described in more detail with reference to the drawings.

### First Example Embodiment

A first example embodiment will be described in more detail with reference to the drawings.

### [System Configuration]

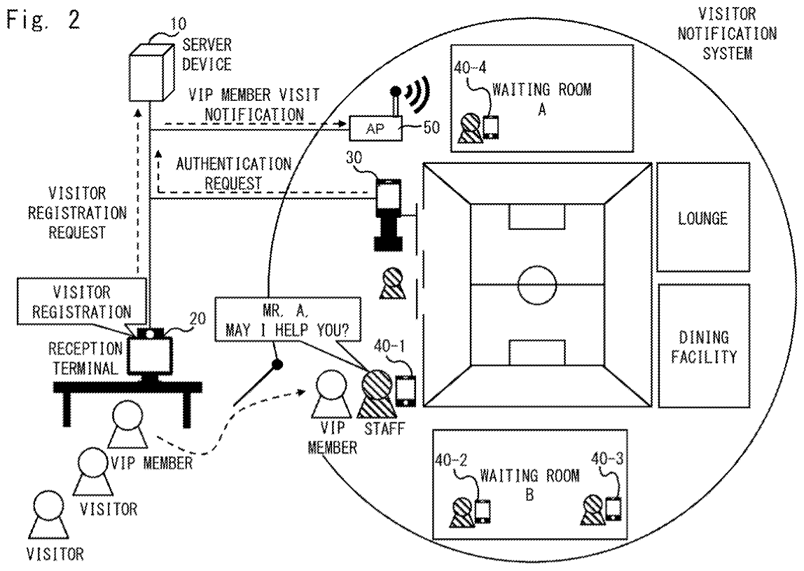

FIG. 2 is a diagram illustrating an example of a schematic configuration of a visitor notification system according to the first example embodiment. Referring to FIG. 2, the visitor notification system includes a server device 10, a reception terminal 20, and an authentication terminal 30.

The visitor notification system according to the first example embodiment is a system that notifies an employee (staff member, especially sales staff member) of an event company or the like of the visit of a customer to an event venue such as a soccer stadium, a baseball stadium, or a concert hall. In particular, the visitor notification system notifies the employee of the visit of a customer important to the event company or the like. In the following description, the important customer is referred to as a very important person (VIP) member.

In the drawings including FIG. 2, a person illustrated in white as a visitor indicates a normal visitor, a person illustrated in white as a VIP member indicates a VIP member, and a hatched person illustrated as staff indicates a staff member of the event company.

The server device 10 is a device that controls the entire visitor notification system. The server device 10 may be installed in the event venue, or may be installed on a network (on a cloud).

The reception terminal 20 is a terminal installed in a reception area of the event venue.

The authentication terminal 30 is a terminal that controls a gate installed at an entrance/exit of a restricted entrance/exit area (for example, a spectator seat of a soccer stadium) of the event venue.

The devices illustrated in FIG. 2 are connected to each other. For example, the reception terminal 20 and the server device 10 are connected to each other by wired or wireless communication means, and are configured to be able to communicate with each other. In addition, the server device 10 is configured to be able to communicate with terminals 40-1 to 40-4 possessed by staff members via an access point 50.

In the following description, the terminals 40-1 to 40-4 will be simply referred to as “terminals 40” unless there is a particular reason to distinguish them. In addition, although the four staff members are illustrated in FIG. 2, it is needless to say that the number of staff members at the event venue is not limited to “four”.

The configuration of the visitor notification system illustrated in FIG. 2 is an example and is not intended to limit the configuration. For example, the system may include a plurality of server devices 10. Furthermore, a plurality of reception areas may be installed around the event venue, and a reception terminal 20 may be installed in each area. Further, a plurality of reception terminals 20 may be installed in each area. In a case where there is a plurality of entrances/exits of the restricted entrance/exit area of the event venue, an authentication terminal 30 may be installed at each entrance/exit.

### [Outline of Operation]

Next, an outline of an operation of the visitor notification system according to the first example embodiment will be described with reference to the drawings.

Visitors including a VIP member register at the reception area which is provided outside or inside the event venue. The reception terminal 20 is a terminal that performs “visitor registration” for the visitors. After the visitor registration is performed, the visitors can receive provision of a service using biometric authentication. For example, a visitor who has completed the visitor registration can pass through the gate (can enter the restricted entrance/exit area) by being biometrically authenticated in the authentication terminal 30.

Note that the above-described visitor registration is an arbitrary procedure, and a visitor who does not desire to receive provision of a service by biometric authentication may not perform the visitor registration. In this case, the visitor presents a ticket to a staff member waiting near the entrance/exit of the restricted entrance/exit area and passes through the gate.

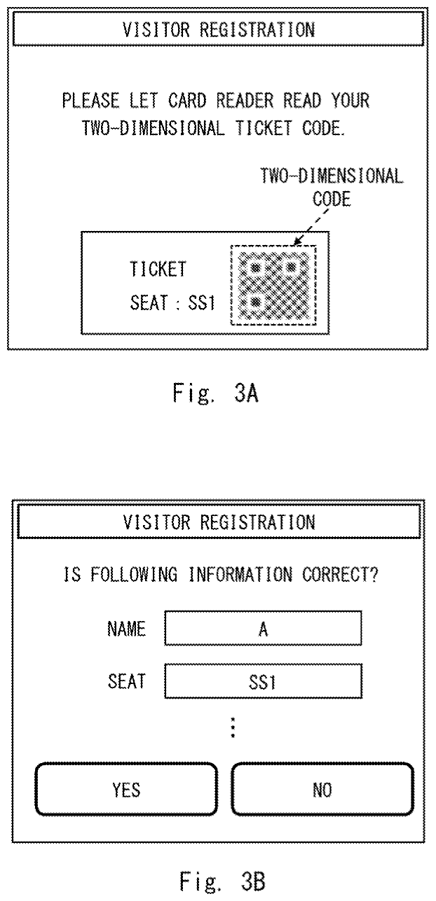

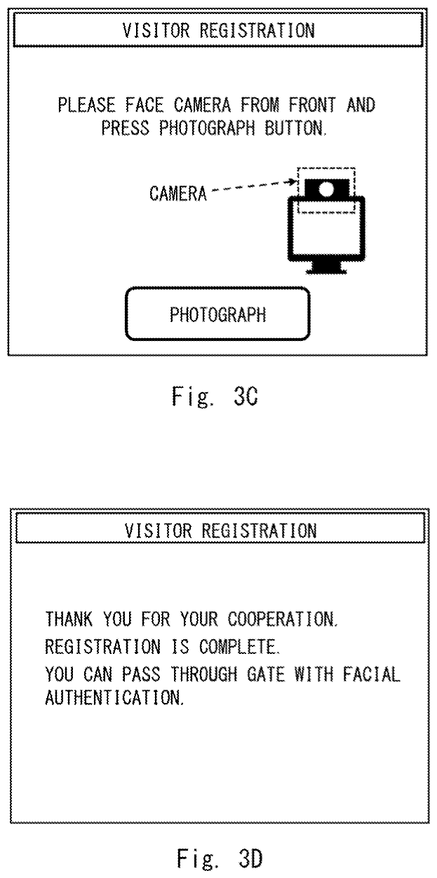

The reception terminal 20 acquires information of a ticket (paper or electronic ticket) possessed by a visitor. For example, the reception terminal 20 performs display as illustrated in FIG. 3A, and acquires the ticket information via a card reader. The ticket information acquired by the reception terminal 20 includes, for example, a name of a ticket purchaser, an event organizer, a date and time of an event, an event venue, a seat assigned to the ticket purchaser, and the like.

The ticket information is described (printed) on the ticket in a form such as a two-dimensional code, for example. The reception terminal 20 reads the ticket information from the two-dimensional code. Note that the issuance of the ticket describing the two-dimensional code is different from the gist of the present application, and thus a detailed description thereof will be omitted.

The reception terminal 20 displays the acquired ticket information, and requests the visitor to confirm whether or not the content thereof is correct (see FIG. 3B). When the visitor determines that there is a mistake in the ticket information (when a NO button illustrated in FIG. 3B is pressed), the reception terminal 20 performs display to direct the visitor to a staff member.

When the visitor determines that there is no mistake in the ticket information (when a YES button illustrated in FIG. 3B is pressed), the reception terminal 20 acquires biometric information of the visitor. Specifically, the reception terminal 20 performs display as illustrated in FIG. 3C to acquire the biometric information of the visitor.

Examples of the biometric information of the visitor include data (feature amounts) calculated from physical characteristics unique to the individual, such as a face, a fingerprint, a voiceprint, a vein, a retina, and a pattern (pattern) of an iris of a pupil. Alternatively, the biometric information may be image data such as a face image or a fingerprint image. The biometric information may include physical characteristics of the resident as information. In the first example embodiment, a case will be described in which biometric information (a face image or a feature amount generated from the face image) regarding a “face” of a person is used.

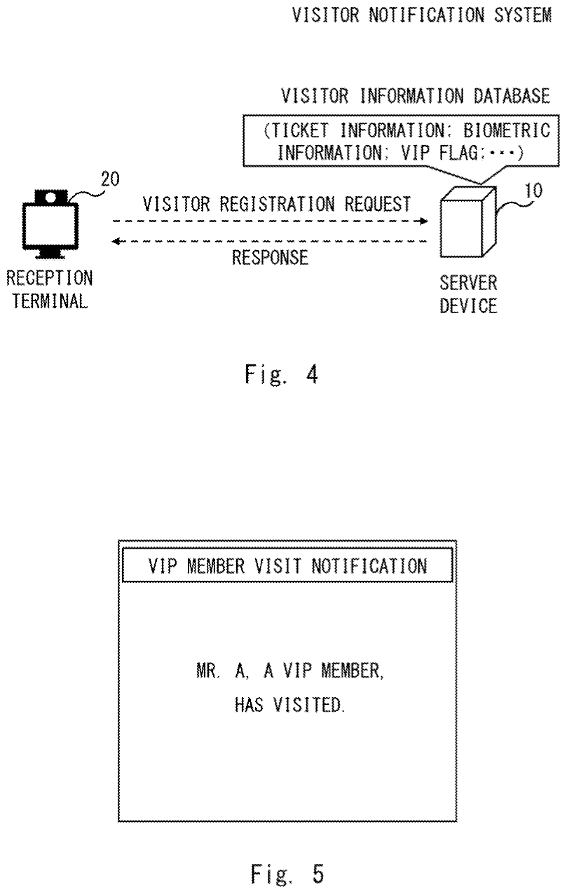

Upon detecting the pressing of a “photograph” button, the reception terminal 20 acquires the biometric information (face image) of the visitor. Upon acquiring the ticket information and the biometric information, the reception terminal 20 transmits a “visitor registration request” including the ticket information and the biometric information to the server device 10 (see FIG. 4).

Upon receiving the visitor registration request, the server device 10 stores the acquired ticket information and the acquired biometric information in association with each other in a “visitor information database”.

In this case, the server device 10 determines whether or not the visitor is a VIP member. For example, the server device 10 refers to a VIP member information database that stores names and the like of VIP members, and determines whether or not the visitor is a VIP.

When the visitor is a VIP, the server device 10 stores in the visitor information database that the visitor is a VIP.

Upon normally processing the visitor registration request, the server device 10 transmits an affirmative response indicating the fact to the reception terminal 20. In this case, the server device 10 may notify the reception terminal 20 that the visitor is a VIP. When the visitor registration request cannot be processed normally (for example, in a case where valid biometric information cannot be obtained), the server device 10 transmits a negative response indicating the fact to the reception terminal 20.

Upon receiving the affirmative response to the visitor registration request, the reception terminal 20 performs display as illustrated in FIG. 3D. The reception terminal 20 notifies the visitor that the visitor registration has been completed by the display as illustrated in FIG. 3D.

Upon receiving the negative response to the visitor registration request, the reception terminal 20 performs display so as to direct the visitor to a staff member.

The description returns to FIG. 2. In a case where it is determined that the visitor is a VIP member when the visitor registration request is processed, the server device 10 notifies the staff members of the visit of the VIP member. Specifically, the server device 10 broadcasts a “VIP member visit notification” to the terminals 40-1 to 40-4 possessed by the staff members. The server device 10 may broadcast a VIP member visit notification including information (for example, the name and the like) of the VIP member.

The terminals 40 that have received the VIP member visit notification notify the staff members of the reception. For example, the terminals 40 perform display as illustrated in FIG. 5 to notify the staff members of the visit of the VIP member.

A staff member who has received the VIP member visit notification goes to the VIP member. The staff member who arrives at the VIP member serves the customer, performs sales activities, and the like.

Next, details of each device included in the visitor notification system according to the first example embodiment will be described.

### [Server Device]

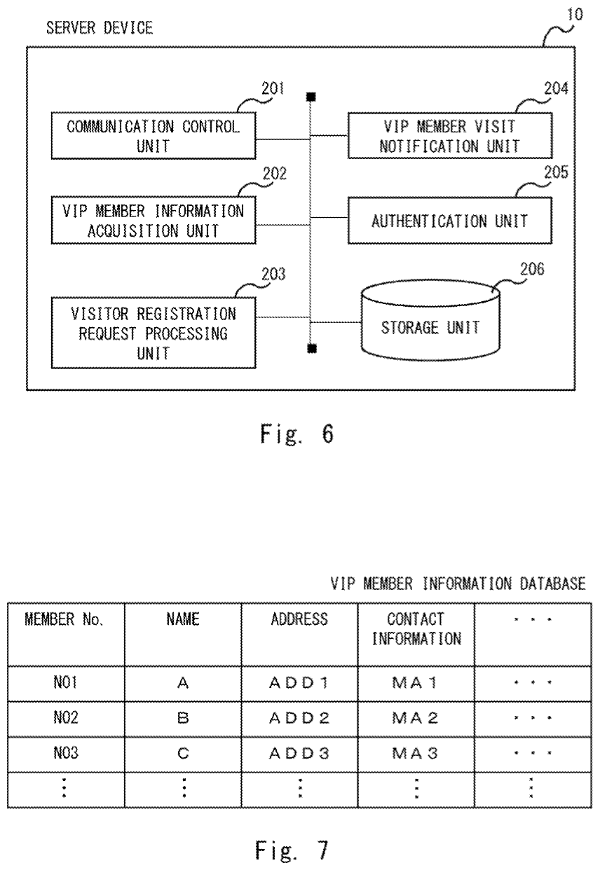

FIG. 6 is a diagram illustrating an example of a processing configuration (processing modules) of the server device 10 according to the first example embodiment. Referring to FIG. 6, the server device 10 includes a communication control unit 201, a VIP member information acquisition unit 202, a visitor registration request processing unit 203, a VIP member visit notification unit 204, an authentication unit 205, and a storage unit 206.

The communication control unit 201 is means for controlling communication with other devices. For example, the communication control unit 201 receives data (packet) from the reception terminal 20. In addition, the communication control unit 201 transmits data to the reception terminal 20. The communication control unit 201 delivers data received from another device to another processing module. The communication control unit 201 transmits data acquired from the other processing module to the other device. In this manner, the other processing module transmits and receives data to and from the other device via the communication control unit 201.

The VIP member information acquisition unit 202 is means for acquiring information (VIP member information) regarding a VIP member. Examples of the VIP member information include a member number, a name, an address, a sex, a date of birth, and a contact information (telephone number, e-mail address) of the VIP member.

The VIP member information acquisition unit 202 acquires the VIP member information using any means. For example, an employee or the like of the event company may input the VIP member information to the server device 10. Alternatively, the VIP member information acquisition unit 202 may acquire the VIP member information via an external storage medium such as Universal Serial Bus (USB). Alternatively, the VIP member information acquisition unit 202 may access an external server that stores the VIP member information and acquire the information. The VIP member information acquisition unit 202 may acquire the VIP member information from the VIP member himself/herself.

The VIP member information acquisition unit 202 stores the acquired VIP member information in the VIP member information database (see FIG. 7).

The visitor registration request processing unit 203 is means for processing the visitor registration request acquired from the reception terminal 20. The visitor registration request processing unit 203 has a function as the above-described acquisition unit and a function as the above-described determination unit. That is, the visitor registration request processing unit 203 acquires, from the reception terminal 20 installed in the event venue, at least ticket information of a ticket presented by a visitor for whom visitor registration is performed in the reception terminal 20. In addition, the visitor registration request processing unit 203 determines, based on the acquired ticket information, whether or not the visitor is a VIP member (first person).

The visitor registration request processing unit 203 generates a feature amount (a feature vector including a plurality of feature amounts) that characterizes the face image from the acquired biometric information (face image). Note that an existing technique can be used for the processing of generating the feature amount, and thus a detailed description thereof will be omitted. For example, the visitor registration request processing unit 203 extracts eyes, a nose, a mouth, and the like as feature points from the face image. Thereafter, the visitor registration request processing unit 203 calculates the position of each feature point and distances between the feature points as feature amounts, and generates a feature vector (vector information characterizing the face image) including the plurality of feature amounts.

The visitor registration request processing unit 203 determines whether or not a visitor who desires visitor registration is a VIP member. The visitor registration request processing unit 203 acquires the name of the visitor from ticket information. The visitor registration request processing unit 203 searches the VIP member information database using the acquired name as a key. In a case where the corresponding name is registered in the database, the visitor registration request processing unit 203 determines that the visitor is a VIP member. In a case where the corresponding name is not registered in the database, the visitor registration request processing unit 203 determines that the visitor is not a VIP member.

In a case where the ticket information includes a member number (member number of a VIP member), the visitor registration request processing unit 203 may use the member number to determine whether or not the visitor is a VIP member. That is, in the disclosure of the present application, information (for example, the membership number, a company name, a mail address, and the like) other than the “name” can be used as the identification information for identifying the VIP member.

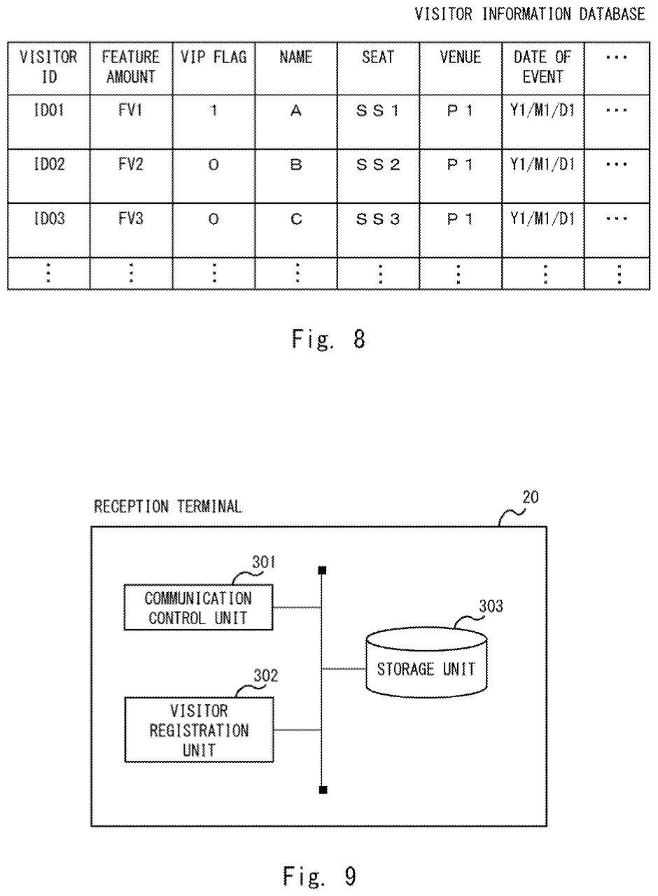

The visitor registration request processing unit 203 registers the generated feature amount and the ticket information in the visitor information database (see FIG. 8). When the visitor is a VIP member, the visitor registration request processing unit 203 sets “1” in a VIP flag field. When the visitor is not a VIP member, the visitor registration request processing unit 203 sets “0” in the VIP flag field.

When the visitor registration request processing unit 203 can normally process the visitor registration request, the visitor registration request processing unit 203 transmits an affirmative response indicating the fact to the reception terminal 20. In this case, the visitor registration request processing unit 203 may notify the reception terminal 20 whether or not the visitor is a VIP member. When the visitor registration request processing unit 203 cannot normally process the visitor registration request, the visitor registration request processing unit 203 transmits a negative response indicating the fact to the reception terminal 20.

When the visitor is a VIP member, the visitor registration request processing unit 203 delivers the ticket information (name of the VIP member or the like) of the VIP member to the VIP member visit notification unit 204.

As described above, the visitor registration request processing unit 203 acquires the ticket information presented by the visitor and the biometric information of the visitor from the reception terminal 20, and stores the ticket information and the biometric information in association with each other in the visitor information database (first database).

The VIP member visit notification unit 204 is means for notifying the staff members of the visit of the VIP member. When the visitor matches the first person (VIP member), the VIP member visit notification unit 204 notifies the second person (staff member) that the person has visited the event venue. More specifically, upon acquiring the ticket information, the VIP member visit notification unit 204 transmits (broadcasts) a VIP visit notification to the terminals 40 possessed by the staff members.

The VIP member visit notification unit 204 may transmit a VIP visit notification including the name and the like of the VIP member to the terminals 40 possessed by the staff members. Furthermore, in a case where more detailed information (for example, information of favorite players of VIP members, information of favorite teams of the VIP members, and the like) regarding each VIP member is registered in the VIP member information database, these pieces of information may also be transmitted to the terminals 40. The staff members can perform more efficient sales activities and the like by acquiring detailed information (favorite players, favorite teams, and the like) regarding the VIP members via the terminals 40.

The authentication unit 205 is means for performing biometric authentication on a visitor. The authentication unit 205 receives an authentication request from the authentication terminal 30 installed in the event venue. The authentication unit 205 extracts a face image from the received authentication request and generates a feature amount from the face image. The authentication unit 205 performs biometric authentication using the generated feature amount and biometric information of each of a plurality of visitors stored in the visitor information database.

The authentication unit 205 sets the feature amount calculated based on the face image acquired from the authentication terminal 30 as a verification target, and performs verification processing with feature amounts registered in the visitor information database. More specifically, the authentication unit 205 sets the calculated feature amount (feature vector) as a verification target, and executes one-to-N (N is a positive integer, and the same applies hereinafter) verification with the plurality of feature amounts registered in the visitor information database.

The authentication unit 205 calculates similarity between the feature amount of the verification target and each of the plurality of feature amounts registered. A chi-square distance, a Euclidean distance, or the like can be used as the similarity. Note that the similarity is lower as the distance is longer, and the similarity is higher as the distance is shorter.

The authentication unit 205 determines that the authentication has failed when a feature amount having a degree of similarity to the feature amount of the verification target equal to or greater than a predetermined value is not present among the plurality of feature amounts registered in the visitor information database.

When the feature amount as described above is present, the authentication unit 205 specifies an entry having the highest similarity. The authentication unit 205 confirms ticket information (a seat, a venue, a date of an event) of the specified entry, and confirms whether or not the ticket information is valid.

For example, the authentication unit 205 confirms whether the venue matches and whether or not the authentication date matches the date of the event, and determines whether or not the ticket is valid. When the ticket is valid, the authentication unit 205 determines that the authentication has succeeded. When the ticket is not valid, the authentication unit 205 determines that the authentication has failed.

The authentication unit 205 notifies the authentication terminal 30 of the authentication result (authentication success, authentication failure).

To transmit the authentication success, the authentication unit 205 transmits an affirmative response indicating the authentication success to the authentication terminal 30. In this case, the authentication unit 205 may transmit an affirmative response including the name and the like of the person authenticated (the person determined to be authenticated successfully; the person authenticated successfully) to the authentication terminal 30. Alternatively, when the person authenticated is a VIP member, the authentication unit 205 may transmit an affirmative response including the fact together with the name to the authentication terminal 30. In addition, when the authentication succeeds, and the person authenticated is not a VIP member, the authentication unit 205 may transmit an affirmative response including the fact to the authentication terminal 30.

To transmit the authentication failure, the authentication unit 205 transmits a negative response indicating the authentication failure to the authentication terminal 30. In this case, the authentication unit 205 may transmit a negative response including the factor of the authentication failure to the authentication terminal 30. Examples of the factor of the authentication failure include “visitor registration not performed” and “the ticket not valid”.

In this manner, the authentication unit 205 acquires the biometric information of the person to be authenticated from the authentication terminal 30, and executes the biometric authentication using the biometric information of the person to be authenticated and the biometric information stored in the visitor information database. The authentication unit 205 transmits the authentication result of the biometric authentication to the authentication terminal 30.

The storage unit 206 is means for storing information necessary for the operation of the server device 10.

### [Reception Terminal]

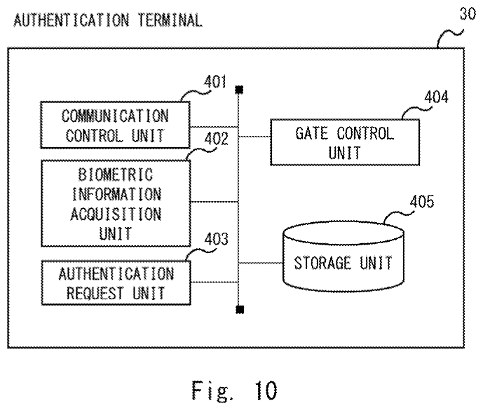

FIG. 9 is a diagram illustrating an example of a processing configuration (processing modules) of the reception terminal 20. Referring to FIG. 9, the reception terminal 20 includes a communication control unit 301, a visitor registration unit 302, and a storage unit 303.

The communication control unit 301 is means for controlling communication with other devices. For example, the communication control unit 301 receives data (packet) from the server device 10. In addition, the communication control unit 301 transmits data to the server device 10. The communication control unit 301 delivers data received from another device to another processing module. The communication control unit 301 transmits data acquired from the other processing module to the other device. In this manner, the other processing module transmits and receives data to and from the other device via the communication control unit 301.

The visitor registration unit 302 is means for registering a visitor. The visitor registration unit 302 displays a screen as illustrated in FIG. 3A to prompt the visitor to bring his or her own ticket into contact with a card reader. The visitor registration unit 302 reads ticket information from a two-dimensional code written on the ticket via the card reader.

The visitor registration unit 302 displays a graphical user interface (GUI) as illustrated in FIG. 3B based on the read ticket information. The visitor registration unit 302 acquires a result of confirming the ticket information of the visitor via the GUI illustrated in FIG. 3B.

When the visitor determines that there is no mistake in the ticket information (when the YES button is pressed), the visitor registration unit 302 photographs the user using a GUI as illustrated in FIG. 3C. The visitor registration unit 302 controls a camera (camera device included in the reception terminal 20) to photograph the visitor in front of the camera. The visitor registration unit 302 determines whether or not a face image of the person is included in the acquired image, and extracts the face image from the acquired image data when the face image is included.

Note that an existing technique can be used for the face image detection processing and the face image extraction processing by the visitor registration unit 302, and thus, a detailed description thereof will be omitted. For example, the visitor registration unit 302 may extract the face image (face area) from the image data by using a learning model learned by a convolutional neural network (CNN). Alternatively, the visitor registration unit 302 may extract the face image using a method such as template matching.

When the face image is successfully extracted, the visitor registration unit 302 transmits a visitor registration request to the server device 10. More specifically, the visitor registration unit 302 transmits the visitor registration request including the extracted face image and the read ticket information to the server device 10.

The visitor registration unit 302 receives a response (affirmative response, negative response) to the visitor registration request from the server device 10.

When the visitor registration is successful (when an affirmative response is received), the visitor registration unit 302 performs display as illustrated in FIG. 3D to notify the visitor that the visitor registration has been completed. The visitor registration unit 302 returns the display illustrated in FIG. 3D to the display (initial screen) as illustrated in FIG. 3A after continuing the display illustrated in FIG. 3D for a predetermined period (for example, for a few seconds).

The storage unit 303 is means for storing information necessary for the operation of the reception terminal 20.

### [Authentication Terminal]

FIG. 10 is a diagram illustrating an example of a processing configuration (processing modules) of the authentication terminal 30. Referring to FIG. 10, the authentication terminal 30 includes a communication control unit 401, a biometric information acquisition unit 402, an authentication request unit 403, a gate control unit 404, and a storage unit 405.

The communication control unit 401 is means for controlling communication with other devices. Specifically, the communication control unit 401 receives data (packet) from the server device 10. In addition, the communication control unit 401 transmits data to the server device 10. The communication control unit 401 delivers data received from another device to another processing module. The communication control unit 401 transmits data acquired from the other processing module to the other device. In this manner, the other processing module transmits and receives data to and from the other device via the communication control unit 401.

The biometric information acquisition unit 402 is means for controlling the camera to acquire biometric information (face image) of a visitor (visitor to the event venue). The biometric information acquisition unit 402 images the front of the device periodically or at a predetermined timing. The biometric information acquisition unit 402 determines whether or not a face image of a person is included in the acquired image, and extracts the face image from the acquired image data when the face image is included.

The biometric information acquisition unit 402 delivers the extracted face image to the authentication request unit 403.

The authentication request unit 403 is means for requesting the server device 10 to perform authentication on a visitor. Specifically, the authentication request unit 403 transmits an authentication request including biometric information (face image) of the person to be authenticated to the server device 10.

The authentication request unit 403 delivers an authentication result (authentication success, authentication failure) received from the server device 10 to the gate control unit 404.

The gate control unit 404 controls the gate according to the authentication result. Specifically, when the authentication result indicates authentication success, the gate control unit 404 opens the gate and permits the user to pass. When the authentication result indicates authentication failure, the gate control unit 404 closes the gate and rejects the passage of the user.

The gate control unit 404 may output a message according to the authentication result. For example, when the authentication is successful, the gate control unit 404 may display a message welcoming participation in the event, or may reproduce the message by a speaker or the like. When the authentication fails, the gate control unit 404 may output a message for guiding the person to the gate where a person in charge is waiting, or may output a message notifying the factor of the authentication failure.

The storage unit 405 stores information necessary for the operation of the authentication terminal 30.

### [Other Devices]

Detailed description of processing configurations and the like related to the access point 50 and the terminals 40 will be omitted. This is because existing devices can be used as the access point 50 and the terminals 40, and it is obvious to those skilled in the art.

### [Operation of Visitor Notification System]

Next, an operation of the visitor notification system according to the first example embodiment will be described.

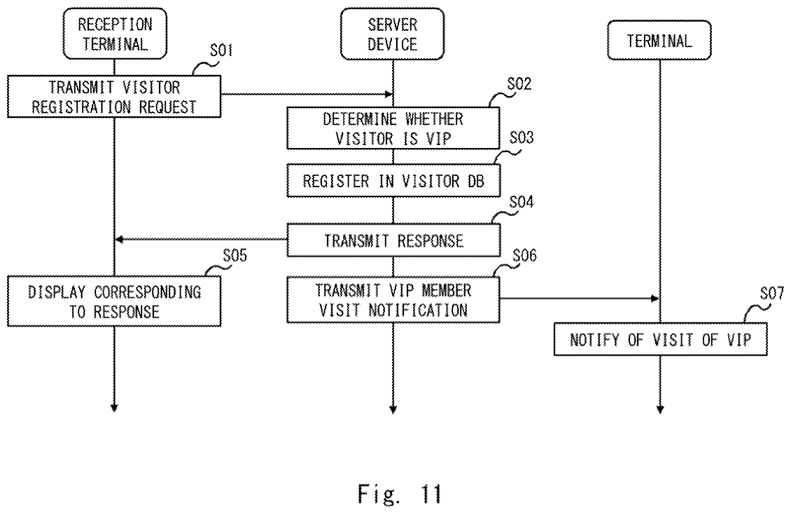

FIG. 11 is a sequence diagram illustrating an example of the operation of the visitor notification system according to the first example embodiment. An operation of registering a visitor who has visited the event venue will be described with reference to FIG. 11. Note that the description of the process of performing authentication on the visitor using the authentication terminal 30 is omitted.

Upon acquiring ticket information from a visitor, the reception terminal 20 transmits a visitor registration request including biometric information of the visitor to the server device 10 (step S01).

The server device 10 determines whether or not the visitor is a VIP member (step S02).

The server device 10 registers the biometric information of the visitor, ticket information of the visitor, and the result of determining whether or not the visitor is a VIP member in the visitor information database (step S03).

The server device 10 transmits a response to the visitor registration request to the reception terminal 20 (step S04).

The reception terminal 20 displays a message or the like corresponding to the response (affirmative response, negative response) (step S05).

When it is determined that the visitor is a VIP member, the server device 10 transmits a VIP member visit notification to the terminals 40 (step S06).

The terminals 40 notify the staff members of the visit of the VIP member (step S07). For example, the terminals 40 may display the name or the like of the VIP member who has visited as illustrated in FIG. 5, or may notify the staff members of only the fact that the VIP member has visited.

In accordance with the message displayed by the terminals 40, a staff member goes to the visiting VIP member and performs sales activities and the like.

As described above, in the visitor notification system according to the first example embodiment, the server device 10 determines whether or not the visitor is a VIP member at the time of visitor registration. When it is determined that the visitor is a VIP member, the server device 10 notifies the staff members (for example, sales persons of the event company) of the determination. In this case, since the server device 10 broadcasts the VIP member visit notification to the terminals 40 possessed by each of the staff members, all the staff members can know the fact that the VIP member has visited. That is, the server device 10 according to the first example embodiment allows the staff members to grasp the visit of the specific customer.

### Second Example Embodiment

A second example embodiment will be described in more detail with reference to the drawings.

In the first example embodiment, it has been described that when a VIP member visits, the staff members at the event venue are notified of the fact (the fact that the VIP member has visited).

In the second example embodiment, a visitor notification system that enables the staff members to perform work (sales activities) efficiently will be described. In the second example embodiment, a server device 10 recognizes the current position of a VIP member and notifies the staff members of the current position of the VIP member.

Since processing configurations of a reception terminal 20 and an authentication terminal 30 according to the second example embodiment can be the same as the configurations according to the first example embodiment, the description thereof will be omitted.

Differences between the first and second example embodiments will be described below.

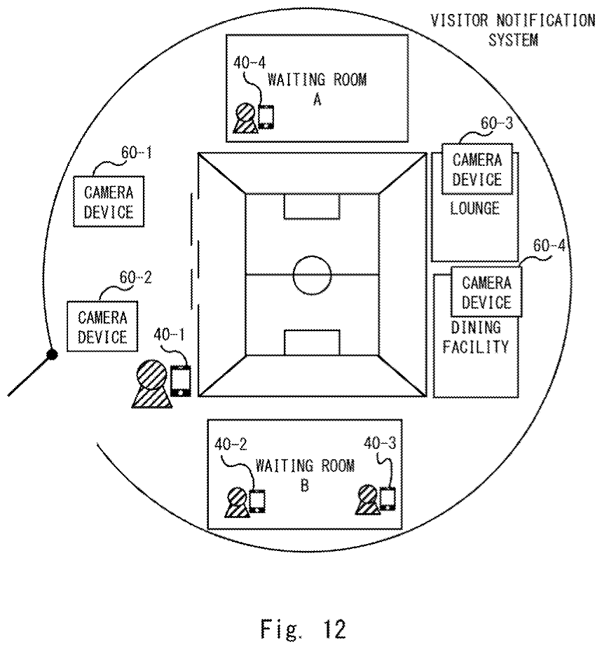

FIG. 12 is a diagram illustrating an example of a schematic configuration of the visitor notification system according to the second example embodiment. As illustrated in FIG. 12, camera devices 60 are arranged at various places in the event venue. Note that it is a matter of course that the arrangement of the camera devices 60 illustrated in FIG. 12 is an example and is not intended to limit the number and arrangement positions of the camera devices 60.

In FIG. 12, illustration of the server device 10, the reception terminal 20, the authentication terminal 30, and the like is omitted. The camera devices 60 are connected to the server device 10 by wired or wireless communication means.

Each camera device 60 transmits, to the server device 10, a camera ID, which is identification information of the device, and image (still image, video) data acquired periodically or at a predetermined timing. As the camera ID, an internet protocol (IP) address or a media access control (MAC) address of the camera device 60 can be used.

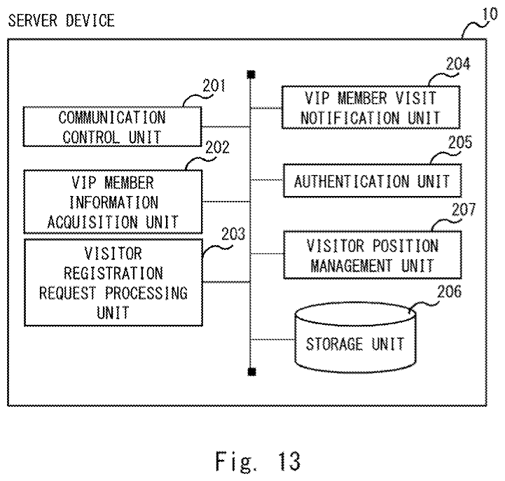

FIG. 13 is a diagram illustrating an example of a processing configuration (processing modules) of the server device 10 according to the second example embodiment. Referring to FIG. 13, a visitor position management unit 207 is added to the configuration according to the first example embodiment.

The VIP member visit notification unit 204 according to the second example embodiment does not immediately transmit a VIP member visit notification even upon receiving ticket information of a VIP member from the visitor registration request processing unit 203. The timing at which the VIP member visit notification unit 204 transmits the VIP member visit notification will be described later.

The visitor position management unit 207 is means (management unit) for managing the current positions of visitors including a VIP member. For example, the visitor position management unit 207 calculates the current position of a visitor by analyzing image data obtained from a camera device 60.

The visitor position management unit 207 tries to extract a face image from the image data acquired from the camera device 60. When the extraction of the face image is successful, the visitor position management unit 207 generates a feature amount from the face image. The visitor position management unit 207 executes one-to-N verification using the generated feature amount and feature amounts registered in the visitor information database.

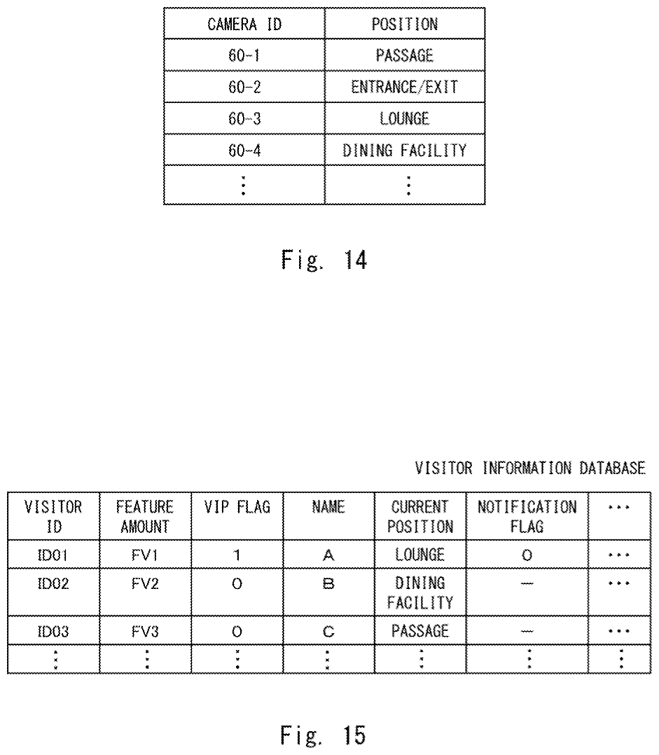

When the 1-to-N verification is successful (when the person of the image data is already registered in the visitor information database), the visitor position management unit 207 calculates the current position of the visitor on the basis of the camera ID of the camera device 60. For example, the visitor position management unit 207 calculates the current position based on table information (see FIG. 14) that defines a relationship between the camera ID of the camera device 60 and the place where the camera device 60 is installed (the place where the image is captured). Note that, in FIG. 14, for easy understanding, the reference numerals of the camera devices 60 are used for the camera IDs.

When the current position is calculated, the visitor position management unit 207 writes information of the calculated position in a current position field of an entry specified by the one-to-N matching (see FIG. 15).

When the current position of the VIP member is written, the visitor position management unit 207 delivers the name and the current position of the VIP member to the VIP member visit notification unit 204. In the example illustrated in FIG. 15, since the visitor of the entry in the first row is a VIP member, when the current position is set in the current position field of the entry, the name “A” and the current position (lounge) of the VIP member are delivered to the VIP member visit notification unit 204.

Upon acquiring the name and the current position of the VIP member, the VIP member visit notification unit 204 transmits (broadcasts) a VIP member visit notification regarding the VIP member to the terminals 40 possessed by the staff members. Specifically, the VIP member visit notification unit 204 transmits the VIP member visit notification including the name and the current position of the VIP member to the terminals 40.

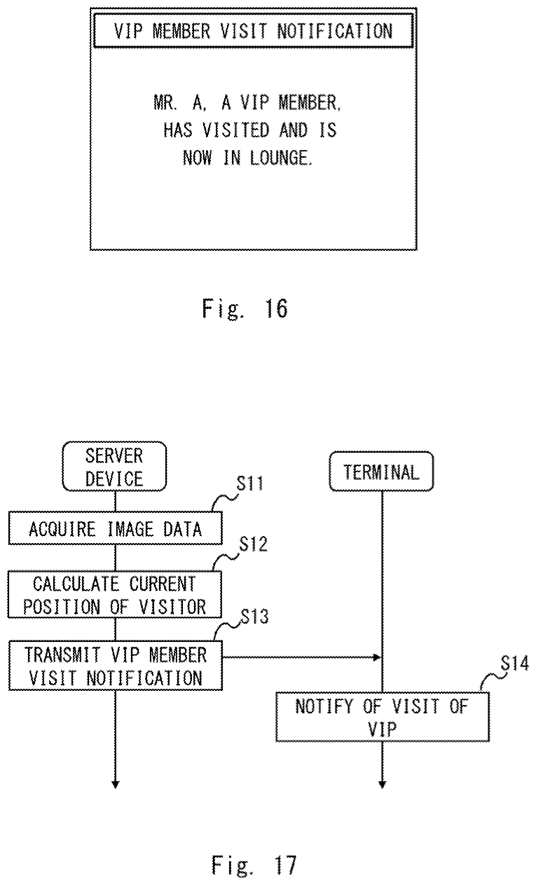

The terminals 40 that have received the notification perform display as illustrated in FIG. 16, for example. A staff member who has viewed the display as illustrated in FIG. 16 goes to the displayed current position and performs sales activities and the like.

Note that the VIP member visit notification unit 204 sets “1” in a notification flag field of the visitor information database for the VIP member for whom the VIP member visit notification has been transmitted. The VIP member visit notification unit 204 does not transmit the VIP member visit notification for a VIP member for whom “1” is already set in the notification flag field. That is, even when the VIP member moves from the place (for example, the lounge) where the VIP member is first photographed to another place (for example, a dining facility) and the VIP member is photographed at the other place, a VIP member visit notification for the same VIP member is not transmitted. However, the VIP member visit notification unit 204 may transmit the VIP member visit notification again for the VIP member photographed at the other place.

When the event ends, each entry of the visitor information database is deleted.

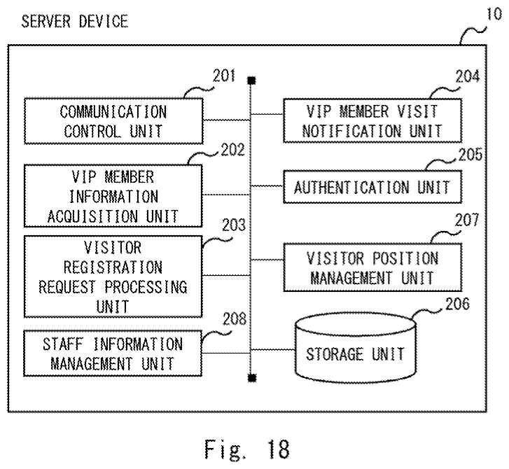

FIG. 17 is a diagram illustrating an example of the operation of the visitor notification system according to the second example embodiment. The operation of the visitor notification system according to the second example embodiment will be described with reference to FIG. 17.

The server device 10 acquires image data from the camera devices 60 (step S11).

The server device 10 analyzes the image data, and calculates the current position of a visitor (step S12).

When the current position of a VIP member is calculated for the first time (when the notification flag is “0”), the server device 10 transmits a VIP member visit notification regarding the first-detected VIP member to the terminals 40 (step S13).

The terminals 40 notify the staff members of the visit of the VIP using the display (display as illustrated in FIG. 16) including the current position of the VIP member (step S14).

As described above, in the visitor notification system according to the second example embodiment, the server device 10 calculates the current position of each visitor by analyzing image data obtained from the camera devices 60 installed in the event venue. The server device 10 transmits a VIP member visit notification regarding a VIP member to the terminals 40 in response to the calculation of the current position of the VIP member. As described above, in the second example embodiment, since the VIP member visit notification is transmitted to the terminals 40 when the current position of the VIP member is determined, a staff member does not get lost in the destination (the place where the VIP member is present) and can perform efficient sales activities. That is, in a case where there is a plurality of entrances of the event venue and visitor registration is performed at each entrance, the staff member does not know which entrance the VIP member comes from, and the staff member who has simply received information that the VIP member has visited does not know which entrance the staff member should go to. In the second example embodiment, such inefficient activities are improved.

### Third Example Embodiment

Next, a third example embodiment will be described in more detail with reference to the drawings.

In the first and second example embodiments, the case where the VIP member visit notification is simultaneously transmitted to the terminals 40 possessed by the staff members has been described.

In the third example embodiment, a case of narrowing down terminals 40 to a terminal 40 (staff member to which a VIP member's visit is notified) to which a VIP member visit notification is transmitted will be described.

A schematic configuration of a visitor notification system according to the third example embodiment can be similar to those described in the first and second example embodiments, and thus the description thereof will be omitted. Since processing configurations of a reception terminal 20 and an authentication terminal 30 according to the third example embodiment can be the same as the configurations according to the first example embodiment, the description thereof will be omitted.

Differences between the first and third example embodiments will be described below.

FIG. 18 is a diagram illustrating an example of a processing configuration (processing modules) of a server device 10 according to the third example embodiment. Referring to FIG. 18, a staff information management unit 208 is added to the configuration according to the second example embodiment.

The staff information management unit 208 is means for managing information (second person information) regarding a staff member (in particular, a staff member who performs sales activities for a VIP member) working in the event venue. In the following description, the information regarding staff members will be referred to as “staff information”.

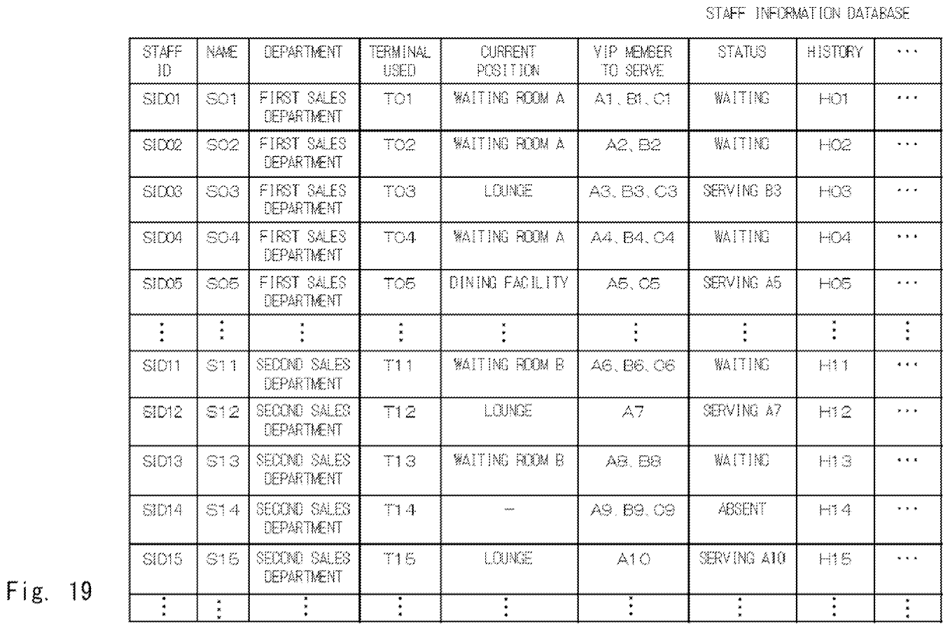

The staff information management unit 208 manages the staff information using a staff information database as illustrated in FIG. 19. As illustrated in FIG. 19, the staff information database stores the staff ID, name, department, terminal used, and current position of each of the staff members working in the event venue, and information of a VIP member of whom the staff member is in charge in association with each other. A terminal used field stores information (IP addresses or the like) for identifying the terminals 40 possessed by the staff members.

Further, the staff information database may include a status field and a history field. The status field stores a state (for example, serving, waiting, absent, or the like) of each staff member. The history field is a field for storing a history of a VIP member served by each staff member. For example, the history field stores, as time series data, the name of a VIP member of whom each staff member was in charge in the past.

A system administrator or the like registers the staff information in the staff information database in advance. Specifically, the system administrator or the like inputs information such as a staff ID, a name, a department, a terminal used, and a VIP member of whom a staff member is in charge.

Furthermore, the staff information management unit 208 calculates the position of each staff member in real time. The staff information management unit 208 calculates the current position of each staff member by any means. For example, similarly to the second example embodiment, the staff information management unit 208 may analyze image data obtained from the camera devices 60 to calculate the current position of each staff member.

Alternatively, the staff information management unit 208 may acquire the position information from the terminals 40 possessed by the staff members. The terminals 40 may generate the position information using a global positioning system (GPS), or may generate the position information based on the strength of a radio wave received from a wireless access point such as Wireless Fidelity (WiFi). The terminals 40 may periodically report the generated position information to the server device 10.

The staff information management unit 208 reflects the calculated current positions in the staff information database.

To transmit a VIP member visit notification, the VIP member visit notification unit 204 refers to the staff information database and selects a staff member (the terminal 40 possessed by the staff member) to which the notification is to be transmitted. The VIP member visit notification unit 204 transmits the VIP member visit notification to the selected staff member. The VIP member visit notification unit 204 refers to the terminal used field for the selected staff member, and transmits a VIP visit notification to an installation value (the IP address of the terminal 40) set in the field.

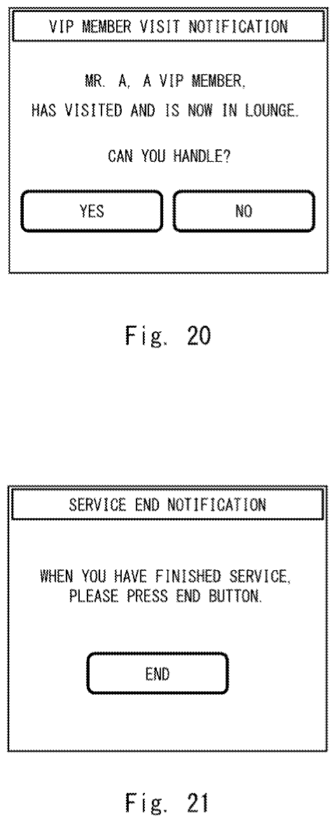

The terminal 40 that has received the VIP visit notification displays a GUI as illustrated in FIG. 20, for example. The staff member who has viewed the display as illustrated in FIG. 20 selects whether or not to go to the designated VIP member in consideration of his/her own situation or the like.

The terminal 40 transmits the selection (handling possible, handling not possible) by the staff member to the server device 10.

When the selection by the staff member indicates handling possible (going to the VIP member), the VIP member visit notification unit 204 sets “serving” in the status field for the staff member in the staff information database illustrated in FIG. 19. In this case, as illustrated in the third row, the fifth row, and the like of FIG. 19, the name of the VIP member served may also be described. For example, in the example in the third row of FIG. 19, it is described that a staff member with a staff ID “SID03” is currently serving a VIP member “B3”. In addition, the VIP member visit notification unit 204 adds the name of the VIP member served to the history field.

When the selection by the staff member indicates handling not possible (unable to go to the VIP member), the VIP member visit notification unit 204 does not update the status field and the history field for the staff member. In this case, the VIP member visit notification unit 204 selects another staff member according to a predetermined rule or the like, and transmits a VIP visit notification to the other staff member.

Alternatively, in a case where the staff member cannot handle, the VIP member visit notification unit 204 may set “handling not possible” in the status field for the staff member. In this case, the VIP member visit notification unit 204 may set the state of the corresponding staff member to “waiting” after a lapse of a predetermined period (for example, 1 hour) from the setting of handling not possible.

The staff member who has finished serving the VIP member operates the terminal 40 and reports the fact to the server device 10. For example, after the display illustrated in FIG. 20, the terminal 40 continues the display as illustrated in FIG. 21 and receives an operation by the staff member. In response to the operation by the staff member, the terminal 40 transmits a “service end notification” to the server device 10.

Upon receiving the notification that the service for the VIP member has ended (upon receiving the service end notification), the VIP member visit notification unit 204 sets the status field for the corresponding staff member to “waiting”.

Next, a specific method when the VIP member visit notification unit 204 selects a staff member to which a VIP member visit notification is transmitted will be described. The VIP member visit notification unit 204 selects, based on the staff information stored in the staff information database (second database), a terminal 40 as a transmission destination of the VIP member visit notification.

For example, the VIP member visit notification unit 204 transmits a VIP member visit notification to a staff member in charge of a VIP member who has visited. For example, in the example illustrated in FIG. 19, when a VIP member with a name “A1” visits, a staff member (staff member in the first row) assigned as a person in charge of the VIP member is selected. In this case, the VIP member visit notification unit 204 selects another staff member when the state of the staff member in charge of the VIP member is other than “waiting”.

Alternatively, the VIP member visit notification unit 204 may transmit the VIP member visit notification to a staff member closest to the VIP member who has visited. For example, in the example illustrated in FIG. 12, when the current position of the VIP member is the “lounge”, a staff member (for example, a staff member waiting in the waiting room A) closest to the lounge is selected. Even in this case, staff members whose statuses are “serving”, “serving not possible”, and “absent” are excluded.

The VIP member visit notification unit 204 may transmit the VIP member visit notification to a staff member belonging to the same department as the staff member in charge of the VIP member who has visited. For example, in FIG. 19, a case where a VIP member whose name is “C3” visits will be considered. In this case, since the staff member in charge indicated in the third row is already serving a customer, another staff member is selected. In this case, the VIP member visit notification unit 204 selects a staff member to which the VIP member visit notification is to be transmitted from among staff members (staff members belonging to the same first sales department) belonging to the same department as the staff member in charge.

The VIP member visit notification unit 204 may select, based on a service history described in the staff information database, a staff member to which the VIP member visit notification is to be transmitted. For example, in a case where a person in charge of a VIP member is not determined in advance (in a case where there is no VIP member contact person field), the VIP member visit notification unit 204 may select a staff member who has the most contact with the VIP member who has visited.

As described above, the VIP member visit notification unit 204 selects a terminal 40 to be a transmission destination of the VIP member visit notification on the basis of a person in charge of a VIP member who has visited, the current position of the staff member, a department to which the staff member belongs, and the state of the staff member. Note that the VIP member visit notification unit 204 may set a priority for the factor of the selection of a transmission destination, and select the transmission destination of the VIP member visit notification according to the priority. Alternatively, the VIP member visit notification unit 204 may select a transmission destination of the VIP member visit notification by combining a plurality of factors. For example, the VIP member visit notification unit 204 may transmit the VIP member visit notification to a staff member closest to a VIP member who has visited among staff members belonging to the same department as the staff member in charge of the VIP member who has visited.

As described above, the server device 10 according to the third example embodiment selects a staff member suitable for welcoming a VIP member who has visited in consideration of the state, position, and the like of the staff member, and notifies the staff member of the visit of the VIP member. As a result, a staff member who knows the VIP member well can handle the VIP member, so that more efficient sales activities and the like can be performed.

Next, hardware of each device constituting the visitor notification system will be described. FIG. 22 is a diagram illustrating an example of a hardware configuration of the server device 10.

The server device 10 can be constituted by an information processing device (so-called computer), and has the configuration illustrated in FIG. 22. For example, the server device 10 includes a processor 311, a memory 312, an input/output interface 313, a communication interface 314, and the like. The components such as the processor 311 are connected by an internal bus or the like, and are configured to be able to communicate with each other.

However, the configuration illustrated in FIG. 22 is not intended to limit the hardware configuration of the server device 10. The server device 10 may include hardware (not illustrated) or may not include the input/output interface 313 as necessary. In addition, the number of processors 311 and the like included in the server device 10 is not limited to the example illustrated in FIG. 22, and for example, a plurality of processors 311 may be included in the server device 10.

The processor 311 is a programmable device such as a central processing unit (CPU), a micro processing unit (MPU), or a digital signal processor (DSP). Alternatively, the processor 311 may be a device such as a field programmable gate array (FPGA) or an application specific integrated circuit (ASIC). The processor 311 is configured to execute various programs including an operating system (OS).

The memory 312 is a random access memory (RAM), a read only memory (ROM), a hard disk drive (HDD), a solid state drive (SSD), or the like. The memory 312 stores an OS program, an application program, and various data.

The input/output interface 313 is an interface of a display device (not illustrated) and an input device (not illustrated). The display device is, for example, a liquid crystal display or the like. The input device is, for example, a device that receives a user operation, such as a keyboard or a mouse.

The communication interface 314 is a circuit, a module, or the like that communicates with another device. For example, the communication interface 314 includes a network interface card (NIC) or the like.

The functions of the server device 10 are implemented by various processing modules. The processing modules are implemented, for example, by the processor 311 executing a program stored in the memory 312. Furthermore, the program can be recorded in a computer-readable storage medium. The storage medium may be a non-transient (non-transitory) medium such as a semiconductor memory, a hard disk, a magnetic recording medium, or an optical recording medium. That is, the present invention can also be embodied as a computer program product. Furthermore, the program can be downloaded via a network or updated using a storage medium storing the program. Further, the processing modules may be implemented by a semiconductor chip.

Note that each of the reception terminal 20, the authentication terminal 30, and the like can also be configured by an information processing device similarly to the server device 10, and since there is no difference in the basic hardware configuration from the server device 10, the description thereof will be omitted. For example, the reception terminal 20 may include a camera device and a card reader.

The server device 10 is equipped with a computer, and the functions of the server device 10 can be implemented by the computer executing the program. In addition, the server device 10 executes a visitor notification method by the program.

### Modified Examples

Note that the configuration, operation, and the like of the visitor notification system described in each of the above-described example embodiments are merely examples, and are not intended to limit the configuration and the like of the system.

In the above-described example embodiments, the case where the server device 10 includes the visitor information database and the like has been described. However, the database may be constructed in a database server different from the server device 10. In addition, the visitor notification system may include various means (visitor registration request processing unit 203, VIP member visit notification unit 204, and the like) described in the above-described example embodiments.

In the above-described example embodiments, the case where the staff members are notified of the visit of a VIP member via the terminals 40 possessed by the staff members has been described. However, the staff members may be notified of the visit of the VIP member by another method. For example, the staff members may be notified of the visit of the VIP member by using a liquid crystal monitor, a speaker, or the like installed in a waiting room.

The reception terminal 20 that performs visitor registration may change the display (the display illustrated in FIG. 3D) at the time of completing the visitor registration according to whether or not a visitor is a VIP member. For example, when the visitor is a VIP member, the reception terminal 20 may display the name of the VIP member and display that the visitor registration is completed. Alternatively, when the visitor is a VIP member, the reception terminal 20 may display that a person (staff member) in charge visits for greetings in the event venue.

When the authentication of a VIP member is successful, the authentication terminal 30 serving as an interface of the biometric authentication may take measures such as opening the gate while displaying the name or the like of the VIP member.

In the above example embodiments, the operation of the authentication terminal 30 and the like has been described by taking the entrance of the restricted entrance/exit area as an example of the service that can be enjoyed by the biometric authentication. However, the service that can be enjoyed by the biometric authentication is not limited to the above. For example, settlement processing regarding purchase of a beverage or the like in the event venue may be performed via biometric authentication.

In the first and second example embodiments, the case where the VIP member visit notification is broadcast to the terminals 40 of the staff members waiting in the event venue has been described. In this case, the terminals 40 may confirm the intention of the staff members by the display as illustrated in FIG. 20 described in the third example embodiment. The terminals 40 transmit results (handling possible, handling not possible) of the confirmation to the server device 10. Upon receiving one or more results indicating “handling possible”, the server device 10 may notify the terminals 40 that a staff member who handles the VIP member is present. Furthermore, in a case where the server device 10 cannot receive a confirmation result indicating “handling possible” even after a predetermined period (for example, 1 minute) has elapsed, the server device 10 may broadcast a VIP member visit notification to the terminals 40 again for the same VIP member.

It may be difficult to acquire the current position of the VIP member from the viewpoint of privacy protection or the like. In this case, the server device 10 may transmit the VIP member visit notification to a staff member closest to the reception area (reception terminal 20).

In the second example embodiments, the case where the staff members are notified of the visit of a VIP member has been described. In this case, the terminals 40 may perform display to clearly indicate the current position of the VIP member on map information of the entire event venue. The server device 10 may transmit a VIP member visit notification including image data indicating the current position of the VIP member on the map to the terminals 40.

In the second example embodiment, the case where, in addition to the current positions of VIP members, the current positions of normal visitors are also managed in the visitor information database has been described. However, the current positions of the normal visitors may not be managed.

In the third example embodiment, it has been described that when a staff member is serving a customer, another staff member handles a VIP member. However, in a case where a plurality of VIP members of whom one staff member is in charge visit the event venue at the same time (substantially at the same time), the server device 10 may instruct the same staff member to handle the plurality of VIP members. For example, the server device 10 may instruct the same staff member to handle (serve) a plurality of VIP members within a predetermined threshold (for example, three persons). That is, the server device 10 may transmit a VIP member visit notification to the same staff member so as to serve a plurality of VIP members within the predetermined threshold as an upper limit.

In the above-described example embodiments, the case where at least one or more VIP members are assigned to each staff member has been described. However, a plurality of staff members may be grouped, and a VIP member may be assigned to each group. For example, in the example illustrated in FIG. 19, VIP members of whom respective groups of the first sales department and the second sales department are in charge may be determined in advance. In this case, the server device 10 may select a transmission destination of a VIP member visit notification from a group in charge of a VIP member who has visited, or may transmit the notification to each staff member belonging to the group in charge.

The server device 10 may create a visitor list of the event venue on the basis of the visitor information database. For example, in the visitor information database as illustrated in FIG. 15, a history is left without overwriting a value in the current position field obtained from the analysis of image data, so that a visitor list including a simple behavior history of each visitor is generated. It is easy to identify a person who had close contact with a person with an infectious disease or the like on the basis of the visitor list.

At the time of visitor registration, the identify of a visitor may be verified. In this case, the reception terminal 20 requests the visitor to present an identification card (for example, driver's license, passport, my number card, or the like). The reception terminal 20 extracts information from an integrated circuit (IC) chip mounted on the identification card using a card reader or the like. The information extracted from the IC chip includes biometric information (face image and the like) of the user who has received the issuance of the identification card. The reception terminal 20 performs one-to-one verification using the face image of the identification card and a face image obtained from a camera. When the verification is successful, the reception terminal 20 may enable the visitor registration.

The server device 10 may analyze image data obtained from a camera device 60 installed in the vicinity of an exit of the event venue so as to detect that a visitor has exited from the event venue. The server device 10 identifies the person who has exited by biometric authentication using the biometric information (face image) obtained from the camera device 60 and biometric information (feature amount) stored in the visitor information database. When the identified person who has exited is a VIP member, the server device 10 notifies the staff members (terminals 40) that the VIP member has exited. After a lapse of a predetermined period from the reception of the exit notification, the staff members may contact the corresponding VIP member to express gratitude for the visit to the event venue.

Some VIP members may not welcome entertainments (greetings) by the staff members. In order to handle such requests of the VIP members, the reception terminal 20 may display a GUI for inputting “entertainment rejection” at the time of visitor registration. That is, the reception terminal 20 may prepare an interface capable of inputting whether or not a VIP member requests entertainment at the time of visitor registration.

In the above-described example embodiments, the case where biometric information regarding a “face image” is transmitted from the reception terminal 20 or the authentication terminal 30 to the server device 10 has been described. However, biometric information regarding a “feature amount generated from the face image” may be transmitted from the reception terminal 20 or the authentication terminal 30 to the server device 10. In this case, the server device 10 does not need to generate the feature amount from the acquired face image.

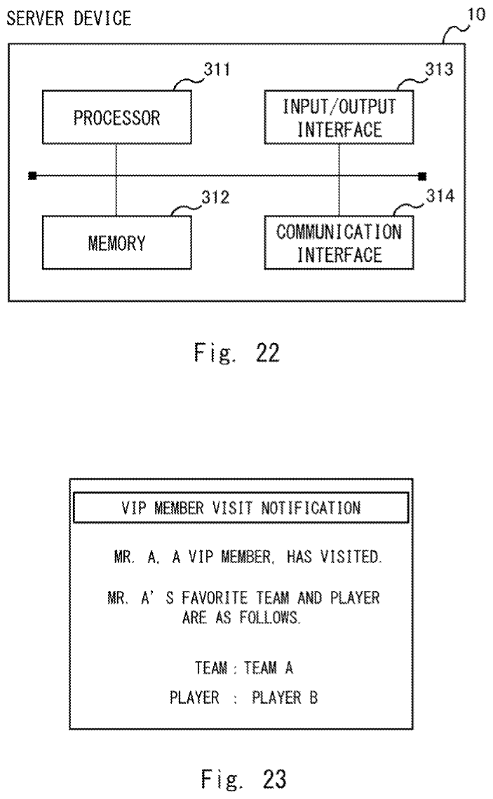

As described above, the terminals 40 notify the staff members of the visit of a VIP member. In this case, in a case where the terminals 40 acquire information of a favorite player or team of the VIP member from the server device 10, the terminals 40 may display information including the information. For example, the terminals 40 may perform display as illustrated in FIG. 23.

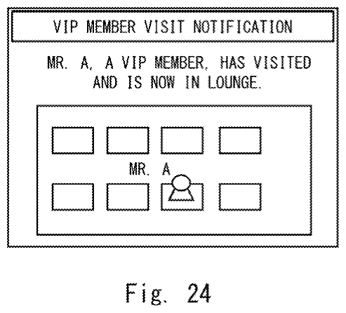

In the above-described example embodiments, it has been described that the server device 10 identifies the current position of a VIP member and transmits a VIP member visit notification including the current position to the terminals 40. In this case, the server device 10 may transmit a VIP member visit notification including map information reflecting the current position of the VIP member to the terminals 40. In this case, the terminals 40 can perform display as illustrated in FIG. 24. The staff members who have viewed the display can easily go to the VIP member. In FIG. 24, the current position of a VIP member is reflected in map information that mimics the internal structure of the lounge.

In the third example embodiment, the server device 10 may include an interface for accessing the staff information database by the staff members (terminals 40). Each staff member can operate the terminal 40 and directly access the staff information database to check the states of the other staff members. For example, when a staff member confirms that none of the staff members have handled a VIP member, the staff member can immediately go to the VIP member. Alternatively, when a staff member checks the presence of a staff member who is responding to a neglected VIP member, the staff member can perform another task without worries.

In the above example embodiments, the case where when a VIP member arrives at the event venue, the staff members are notified of the fact has been described. However, a person other than the VIP member may be registered in advance, and the staff members may be notified of the visit of the person. For example, when information of a director or the like of the event company is registered in advance, the person enters the event venue, and registers biometric information, a visit notification may be transmitted to the terminals 40, or the current position may be recognized (tracked).

A form of data transmission and reception between the devices (for example, the server device 10 and the reception terminal 20) is not particularly limited, but data that is transmitted and received between the devices may be encrypted. Biometric information is transmitted and received between these devices, and it is desirable that encrypted data be transmitted and received between these devices in order to appropriately protect the biometric information.

In the flowchart (flowchart, sequence diagram) used in the above description, the plurality of steps (processes) is described in order, but the order in which the steps are executed in the example embodiment is not limited to the described order. In the example embodiment, for example, the order of the illustrated steps can be changed, for example, each process can be executed in parallel, within a range in which there is no problem in terms of content.

The above-described example embodiments have been described in detail in order to facilitate understanding of the disclosure of the present application, and it is not intended that all the configurations described above are necessary. In addition, in a case where a plurality of example embodiments has been described, each example embodiment may be used alone or in combination. For example, a part of the configuration of an example embodiment can be replaced with the configuration of another example embodiment, or the configuration of another example embodiment can be added to the configuration of the example embodiment. Furthermore, it is possible to add, remove, and replace other configurations for a part of the configuration of the example embodiment.

Although the industrial applicability of the present invention is apparent from the above description, the present invention can be suitably applied to a visitor notification system operated in an event venue or the like.

Some or all of the above-described example embodiments can be described as the following supplementary notes, but are not limited to the following.

### [Supplementary Note 1]

A server device including:
an acquisition unit configured to acquire, from a reception terminal installed in an event venue, ticket information of a ticket presented by a visitor for whom visitor registration is to be performed in the reception terminal;
a determination unit configured to determine, based on the ticket information, whether or not the visitor matches a first person; and
a notification unit configured to notify, when the visitor matches the first person, a second person that the first person has visited the event venue.

### [Supplementary Note 2]

The server device according to supplementary note 1, wherein the acquisition unit acquires biometric information of the visitor together with the ticket information presented by the visitor from the reception terminal, and stores the ticket information and the biometric information in association with each other in a first database.

### [Supplementary Note 3]

The server device according to supplementary note 2, wherein the server device acquires biometric information of a person to be authenticated from an authentication terminal, performs biometric authentication using the biometric information of the person to be authenticated and the biometric information stored in the first database, and transmits a result of the authentication to the authentication terminal.

### [Supplementary Note 4]

The server device according to supplementary note 2 or 3, wherein the biometric information is a face image or a feature amount generated from the face image.

### [Supplementary Note 5]

The server device according to any one of supplementary notes 1 to 4, wherein the notification unit transmits a first person visit notification including a name of the first person to a terminal possessed by the second person.

### [Supplementary Note 6]

The server device according to supplementary note 5, further including a management unit configured to manage a current position of the visitor,
wherein the notification unit transmits the first person visit notification including a current position of the first person to the terminal.

### [Supplementary Note 7]

The server device according to supplementary note 6, wherein
the management unit calculates the current position of the visitor by analyzing image data obtained from a camera device installed in the event venue, and
the notification unit transmits the first person visit notification to the terminal in response to the calculation of the current position of the first person.

### [Supplementary Note 8]

The server device according to any one of supplementary notes 5 to 7, further including a second database that stores second person information regarding the second person, wherein
the notification unit selects, based on the second person information, the terminal to be a transmission destination of the first person visit notification.

### [Supplementary Note 9]

The server device according to supplementary note 8, wherein
the second database stores the second person who is in charge of the first person, and
the notification unit transmits the first person visit notification to the terminal possessed by the person in charge of the first person.

### [Supplementary Note 10]

The server device according to supplementary note 8 or 9, wherein
the second database stores a current position of the second person, and
the notification unit selects a destination of the first person visit notification based on the current position of the second person.

### [Supplementary Note 11]

The server device according to any one of supplementary notes 8 to 10, wherein
the second database stores a department to which the second person belongs, and
the notification unit selects a destination of the first person visit notification based on the department to which the second person belongs.

### [Supplementary Note 12]

The server device according to any one of supplementary notes 8 to 11, wherein
the second database stores a state of the second person, and
the notification unit selects a destination of the first person visit notification based on the state of the second person.

### [Supplementary Note 13]

A visitor notification system including:
a reception terminal installed in an event venue; and
a server device connected to the reception terminal,
wherein the server device includes:
an acquisition unit configured to acquire, from the reception terminal, ticket information of a ticket presented by a visitor for whom visitor registration is to be performed in the reception terminal;
a determination unit configured to determine, based on the ticket information, whether or not the visitor matches a first person; and
a notification unit configured to notify, when the visitor matches the first person, a second person that the first person has visited the event venue.

### [Supplementary Note 14]

A visitor notification method including, by a server device:
acquiring, from a reception terminal installed in an event venue, ticket information of a ticket presented by a visitor for whom visitor registration is to be performed in the reception terminal;
determining, based on the ticket information, whether or not the visitor matches a first person; and
notifying, when the visitor matches the first person, a second person that the first person has visited the event venue.

### [Supplementary Note 15]

A computer-readable storage medium storing a program for causing a computer installed in a server device to execute:
processing of acquiring, from a reception terminal installed in an event venue, ticket information of a ticket presented by a visitor for whom visitor registration is to be performed in the reception terminal;
processing of determining, based on the ticket information, whether or not the visitor matches a first person; and
processing of notifying, when the visitor matches the first person, a second person that the first person has visited the event venue.

The disclosures of the cited prior art literatures are incorporated herein by reference. Although the present invention has been described above with reference to the example embodiments, the present invention is not limited to the above-described example embodiments. It will be understood by those skilled in the art that these example embodiments are exemplary only and that various variations are possible without departing from the scope and spirit of the invention. That is, it goes without saying that the present invention includes various variations and modifications that can be made by those skilled in the art in accordance with the entire disclosure including the claims and the technical idea.

### REFERENCE SIGNS LIST

10, 100 SERVER DEVICE
20 RECEPTION TERMINAL
30 AUTHENTICATION TERMINAL
40, 40-1 to 40-4 TERMINAL
50 ACCESS POINT
60-1 to 60-4 CAMERA DEVICE
101 ACQUISITION UNIT
102 DETERMINATION UNIT
103 NOTIFICATION UNIT
201, 301, 401 COMMUNICATION CONTROL UNIT
202 VIP MEMBER INFORMATION ACQUISITION UNIT
203 VISITOR REGISTRATION REQUEST PROCESSING UNIT
204 VIP MEMBER VISIT NOTIFICATION UNIT
205 AUTHENTICATION UNIT
206, 303, 405 STORAGE UNIT
207 VISITOR POSITION MANAGEMENT UNIT
208 STAFF INFORMATION MANAGEMENT UNIT
302 VISITOR REGISTRATION UNIT
311 PROCESSOR
312 MEMORY
313 INPUT/OUTPUT INTERFACE
314 COMMUNICATION INTERFACE
402 BIOMETRIC INFORMATION ACQUISITION UNIT
403 AUTHENTICATION REQUEST UNIT
404 GATE CONTROL UNIT

What is claimed is:

1. A server device comprising:
a memory configured to store instructions; and
a processor configured to execute the instructions to:
acquire, from a reception terminal installed in an event venue, ticket information of a ticket presented by a visitor for whom visitor registration is to be performed in the reception terminal;
determine, based on the ticket information, whether or not the visitor matches a first person; and
notify, when the visitor matches the first person, a second person that the first person has visited the event venue.

2. The server device according to claim 1, wherein the processor is further configured to execute the instructions to:
acquire biometric information of the visitor together with the ticket information presented by the visitor from the reception terminal, and store the ticket information and the biometric information in association with each other in a first database.

3. The server device according to claim 2, wherein the server device acquires biometric information of a person to be authenticated from an authentication terminal, performs biometric authentication using the biometric information of the person to be authenticated and the biometric information stored in the first database, and transmits a result of the authentication to the authentication terminal.

4. The server device according to claim 2, wherein the biometric information is a face image or a feature amount generated from the face image.

5. The server device according to claim 1, wherein the processor is further configured to execute the instructions to:
transmit a first person visit notification including a name of the first person to a terminal possessed by the second person.

6. The server device according to claim 5, wherein the processor is further configured to execute the instructions to:
manage a current position of the visitor, and
transmit the first person visit notification including a current position of the first person to the terminal.

7. The server device according to claim 6, wherein the processor is further configured to execute the instructions to:
calculate the current position of the visitor by analyzing image data obtained from a camera device installed in the event venue, and
transmit the first person visit notification to the terminal in response to the calculation of the current position of the first person.

8. The server device according to claim 5, further comprising a second database that stores second person information regarding the second person,
wherein the processor is further configured to execute the instructions to:
select, based on the second person information, the terminal to be a transmission destination of the first person visit notification.

9. The server device according to claim 8, wherein
the second database stores the second person who is in charge of the first person, and
the processor is further configured to execute the instructions to:
transmit the first person visit notification to the terminal possessed by the person in charge of the first person.

10. The server device according to claim 8, wherein
the second database stores a current position of the second person, and
the processor is further configured to execute the instructions to:
select a destination of the first person visit notification based on the current position of the second person.

11. The server device according to claim 8, wherein
the second database stores a department to which the second person belongs, and
the processor is further configured to execute the instructions to:
select a destination of the first person visit notification based on the department to which the second person belongs.

12. The server device according to claim 8, wherein
the second database stores a state of the second person, and
the processor is further configured to execute the instructions to:
select a destination of the first person visit notification based on the state of the second person.

13. A visitor notification system comprising:
a reception terminal installed in an event venue; and
a server device connected to the reception terminal,
wherein the server device includes:
a memory configured to store instructions; and
a processor configured to execute the instructions to:
acquire, from the reception terminal, ticket information of a ticket presented by a visitor for whom visitor registration is to be performed in the reception terminal;
determine, based on the ticket information, whether or not the visitor matches a first person; and
notify, when the visitor matches the first person, a second person that the first person has visited the event venue.

14. A visitor notification method comprising, by a server device:
acquiring, from a reception terminal installed in an event venue, ticket information of a ticket presented by a visitor for whom visitor registration is to be performed in the reception terminal;
determining, based on the ticket information, whether or not the visitor matches a first person; and
notifying, when the visitor matches the first person, a second person that the first person has visited the event venue.

15. A computer-readable storage medium storing a program for causing a computer installed in a server device to execute:
processing of acquiring, from a reception terminal installed in an event venue, ticket information of a ticket presented by a visitor for whom visitor registration is to be performed in the reception terminal;
processing of determining, based on the ticket information, whether or not the visitor matches a first person; and
processing of notifying, when the visitor matches the first person, a second person that the first person has visited the event venue.
